(19) United States
(12) Patent Application Publication
(10) Pub. No.: US 2022/0234500 A1
(43) Pub. Date: Jul. 28, 2022

(54) ALARM SOUND PROCESSING APPARATUS, ALARM SOUND PROCESSING METHOD, AND PROGRAM

(71) Applicant: NIPPON TELEGRAPH AND TELEPHONE CORPORATION, Tokyo (JP)

(72) Inventors: Kazunori KOBAYASHI, Tokyo (JP); Hiroaki ITO, Tokyo (JP); Shin MURATA, Tokyo (JP)

(73) Assignee: NIPPON TELEGRAPH AND TELEPHONE CORPORATION, Tokyo (JP)

(21) Appl. No.: 17/611,901

(22) PCT Filed: May 22, 2019
(86) PCT No.: PCT/JP2019/020214

§ 371 Date: Nov. 16, 2021

(51) Int. Cl. B60Q 9/00; B60T 7/12; B60T 8/17

(52) U.S. Cl. CPC B60Q 9/00; B60T 8/17; B60T 7/12

(57) ABSTRACT

Provided is a technology capable of supporting an operation of a car by a driver when an alarm sound notifying the approach of a train is sounding at a railroad crossing. The alarm sound processing apparatus includes: an observed sound sensor that generates an observed sound signal from an observed sound or vibration related to the observed sound; an alarm sound detection unit that generates an alarm sound detection result indicating whether the observed sound contains an alarm sound at a railroad crossing from the observed sound signal; and an alarm sound reaction unit that executes processing for issuing a warning to notify a driver that a train is approaching the railroad crossing and/or executes processing for applying a brake to a car driven by the driver when the alarm sound detection result indicates that the alarm sound is contained.

### TECHNICAL FIELD

The present invention relates to a technique for detecting an alarm sound at a railroad crossing and taking actions.

### BACKGROUND ART

Cars equipped with a function of notifying a driver of danger by a warning sound and display or automatically applying a brake when a moving vehicle is about to collide with a preceding vehicle have been on the market. The function detects an object by using a camera, a radar, an ultrasonic sensor, or the like, and avoids danger. In recent years, such a function for supporting the driving of a driver has been developed actively.

### CITATION LIST

### Non-Patent Literature

Non-Patent Literature 1: Japan Automobile Federation (JAF) Latest System for Supporting Driver “Inquiry about ASV (Advanced Safety Car),” [online], [Retrieved Apr. 19, 2019.], Internet <URL: http://www.jaf.or.jp/eco-safety/asv_cg/index.htm>

### SUMMARY OF THE INVENTION

### Technical Problem

A scene at a railroad crossing will be considered. At the railroad crossing, a driver is warned of the approach of a train aurally by an alarm and visually by a crossing gate. However, some drivers stop in front of the railroad crossing with the window closed and pass through the railroad crossing with the window closed. Further, the view from the driver's seat may be narrowed by some object being placed in front of the driver's seat, and the driver cannot visually recognize the railroad crossing sufficiently.

There has been a need for a technique for appropriately notifying the driver of the approach of a train so that even in a situation where the grasp of the danger is prevented, the driver's reaction is not delayed. There has also been a need for a technique for preventing the car from starting, even when the car has been stopped in front of the railroad crossing, due to the driver's erroneous operation despite a train being approaching.

Therefore, it is an object of the present invention to provide a technique capable of supporting an operation of a car by a driver when an alarm sound notifying the approach of a train is sounding at a railroad crossing.

### Means for Solving the Problem

An aspect of the present invention includes: an observed sound sensor that generates an observed sound signal from an observed sound or vibration related to the observed sound; an alarm sound detection unit that generates an alarm sound detection result indicating whether the observed sound contains an alarm sound at a railroad crossing from the observed sound signal; and an alarm sound reaction unit that executes processing for issuing a warning to notify a driver that a train is approaching the railroad crossing and/or executes processing for applying a brake to a car driven by the driver when the alarm sound detection result indicates that the alarm sound is contained.

### Effects of the Invention

According to the present invention, it is possible to support an operation of a car by a driver when an alarm sound notifying the approach of a train is sounding at a railroad crossing.

### BRIEF DESCRIPTION OF DRAWINGS

FIG. 1 is a block diagram showing an example of a configuration of an alarm sound processing apparatus 100.

FIG. 2 is a flowchart showing an example of the operation of the alarm sound processing apparatus 100.

FIG. 3 is a block diagram showing an example of a configuration of an alarm sound detection unit 120.

FIG. 4 is a flowchart showing an example of the operation of the alarm sound detection unit 120.

FIG. 5 is a block diagram showing an example of the configuration of the alarm sound detection unit 120.

FIG. 6 is a flowchart showing an example of the operation of the alarm sound detection unit 120.

FIG. 7 is a block diagram showing an example of a configuration of an alarm sound processing apparatus 200.

FIG. 8 is a flowchart showing an example of the operation of the alarm sound processing apparatus 200.

FIG. 9 is a block diagram showing an example of a configuration of an alarm sound detection unit 220.

FIG. 10 is a flowchart showing an example of the operation of the alarm sound detection unit 220.

FIG. 11 is a block diagram showing an example of the configuration of the alarm sound detection unit 220.

FIG. 12 is a flowchart showing an example of the operation of the alarm sound detection unit 220.

### DESCRIPTION OF EMBODIMENTS

Hereinafter, embodiments of the present invention will be described in detail. Constituent units having the same functions are denoted by the same reference numerals, and a redundant description thereof will be omitted.

### First Embodiment

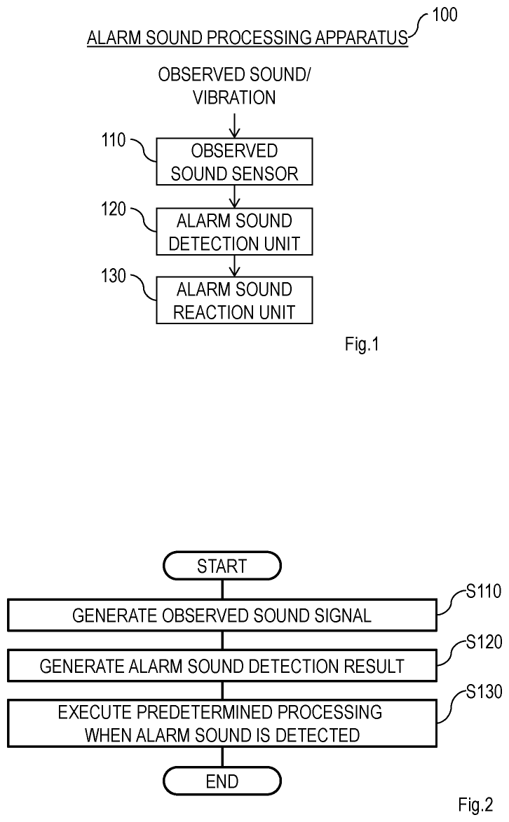

Hereinafter, an alarm sound processing apparatus 100 will be described with reference to FIGS. 1 and 2. FIG. 1 is a block diagram showing the configuration of the alarm sound processing apparatus 100. FIG. 2 is a flowchart showing the operation of the alarm sound processing apparatus 100. As shown in FIG. 1, the alarm sound processing apparatus 100 includes an observed sound sensor 110, an alarm sound detection unit 120, and an alarm sound reaction unit 130. The alarm sound processing apparatus 100 includes N (N is an integer equal to or larger than 1) observed sound sensors 110.

The operation of the alarm sound processing apparatus 100 will be described below with reference to FIG. 2.

In S110, the observed sound sensor 110 generates an observed sound signal from a sound observed in a car driven by a driver (hereinafter referred to as an observed sound) and vibration related to the observed sound and outputs the generated signal. Examples of the observed sound sensor 110 are a microphone and a vibration sensor. That is, the observed sound sensor 110 is mounted on the car for the purpose of detecting an alarm sound notifying that a train is approaching at a railroad crossing and vibration related to the alarm sound.

In S120, the alarm sound detection unit 120 uses the observed sound signal generated in S110 as an input to generate an alarm sound detection result, indicating whether or not the observed sound contains the alarm sound at the railroad crossing, from the observed sound signal and output the generated result.

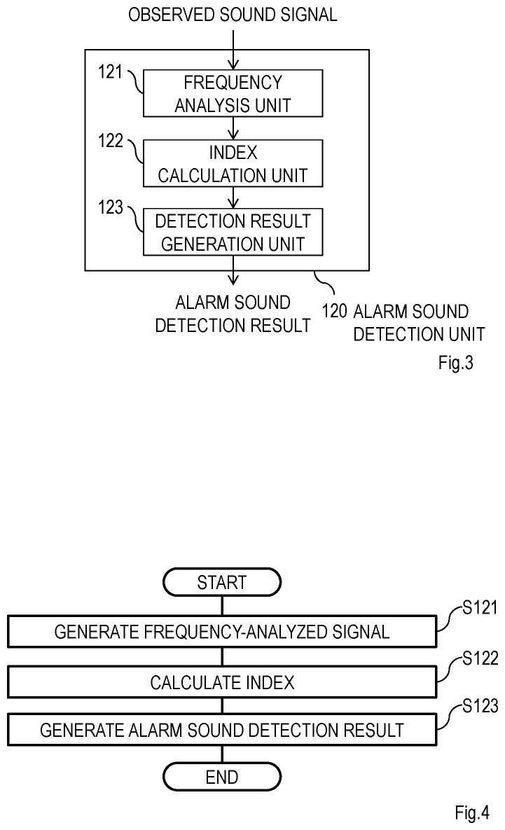

Hereinafter, an example of the alarm sound detection unit 120 will be described with reference to FIGS. 3 and 4. FIG. 3 is a block diagram showing the configuration of the alarm sound detection unit 120. FIG. 4 is a flowchart showing the operation of the alarm sound detection unit 120. As shown in FIG. 3, the alarm sound detection unit 120 includes a frequency analysis unit 121, an index calculation unit 122, and a detection result generation unit 123.

The operation of the alarm sound detection unit 120 will be described below with reference to FIG. 4.

In S121, the frequency analysis unit 121 uses the observed sound signal generated in S110 as an input to generate a frequency-analyzed signal from the observed sound signal and output the generated signal. As the frequency-analyzed signal, the frequency analysis unit 121 may generate, for example, a frequency-domain signal obtained by a frequency-domain transform in which, for example, a window is multiplied by a frame size of several tens to several hundreds of milliseconds (ms), and a Fourier transform is performed. Further, as the frequency-analyzed signal, the frequency analysis unit 121 may generate, for example, a power spectrum obtained by calculating the power of the frequency-domain signal obtained by the frequency-domain transform. Moreover, as the frequency-analyzed signal, the frequency analysis unit 121 may generate, for example, a mel-spectrum obtained by averaging the frequency-domain signal, which is obtained by the frequency-domain transform, on a logarithmic scale.

In S122, the index calculation unit 122 uses the frequency-analyzed signal generated in S121 as an input to calculate an index, indicating the degree of possibility that the observed sound contains the alarm sound at the railroad crossing, from the frequency-analyzed signal and output the index. The index calculation unit 122 can be configured, for example, as a neural network that uses a frequency-analyzed signal of M (M is an integer equal to or larger than 1) frames as an input to output the likelihood indicating the degree of possibility that the observed sound contains the alarm sound at the railroad crossing. In this case, the neural network may learn in advance by using a frequency-analyzed signal generated from a sound containing the alarm sound. Further, for example, the index calculation unit 122 may use a recording unit (not shown), in which a frequency-analyzed signal generated from a sound containing the alarm sound is recorded, to calculate a correlation between the frequency-analyzed signal generated in S121 and the frequency-analyzed signal recorded in the recording unit and generate the correlation value as an index.

In S123, the detection result generation unit 123 uses the index calculated in S122 as an input to generate an alarm sound detection result from the index and output the generated result. When the index is larger than a predetermined threshold or is equal to or larger than the predetermined threshold, the detection result generation unit 123 may generate an alarm sound detection result indicating that the alarm sound is contained, and in other cases, the detection result generation unit 123 may generate an alarm sound detection result indicating that the alarm sound is not contained.

In S130, the alarm sound reaction unit 130 uses the alarm sound detection result generated in S120 as an input, and executes predetermined processing when the alarm sound detection result indicates that the alarm sound is contained. An example of the processing to be executed is the processing of issuing a warning notifying the driver that a train is approaching the railroad crossing. A voice or an image may be used for the warning. Another example of the processing to be executed is the processing of applying a brake to the car driven by the driver. Further, these two examples of the processing may be executed.

### Modification

The alarm sound detection unit 120 may be configured to remove a stationary sound contained in the observed sound (vibration related to a stationary sound contained in vibration related to the observed sound).

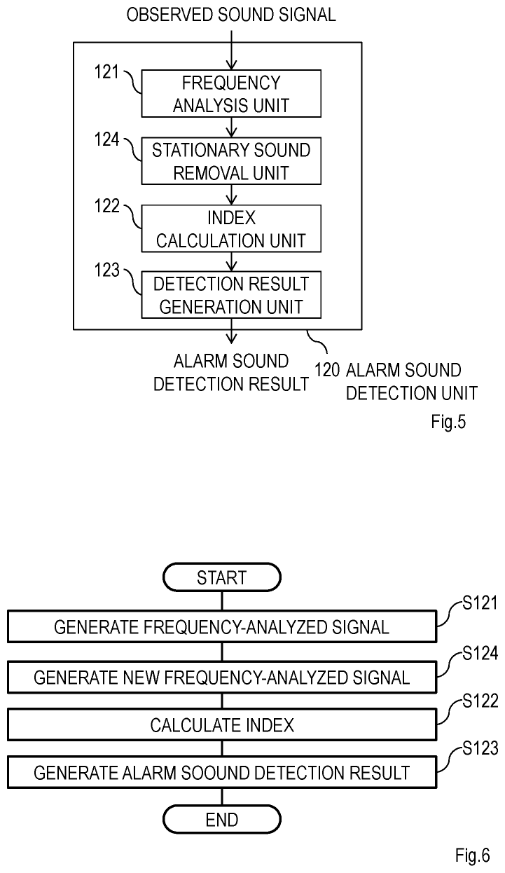

Hereinafter, an example of the alarm sound detection unit 120 will be described with reference to FIGS. 5 and 6. FIG. 5 is a block diagram showing the configuration of the alarm sound detection unit 120. FIG. 6 is a flowchart showing the operation of the alarm sound detection unit 120. As shown in FIG. 5, the alarm sound detection unit 120 includes the frequency analysis unit 121, a stationary sound removal unit 124, the index calculation unit 122, and the detection result generation unit 123.

The operation of the alarm sound detection unit 120 will be described below with reference to FIG. 6. Here, only the operation of the stationary sound removal unit 124 will be described.

In S124, the stationary sound removal unit 124 uses the frequency-analyzed signal generated in S121 as an input to generate a frequency-domain stationary sound signal corresponding to a stationary sound contained in the observed sound or vibration related to a stationary sound contained in vibration related to the observed sound from the frequency-analyzed signal. Further, the stationary sound removal unit 124 outputs, as a new frequency-analyzed signal, a signal generated by subtracting the frequency- domain stationary sound signal from the frequency-analyzed signal. The stationary sound contained in the observed sound includes, for example, a sound emitted from the car such as an engine sound, and a sound caused by the contact between the car and the road. Each of the sounds may be a sound caused by the car driven by the driver, may be a sound caused by another car, or may be a sound containing both of those sounds. The frequency-domain stationary sound signal can be determined as a stationary noise component by using an average over a long period of time (e.g., several tens of seconds) for the frequency-analyzed signal.

According to the embodiment of the present invention, it is possible to support the operation of the car by the driver when an alarm sound notifying the approach of a train is sounding at a railroad crossing. Specifically, it is possible to call the driver's attention by notifying that a train is approaching a railroad crossing or to apply a brake to the car driven by the driver. Hence it is possible to prevent the occurrence of an accident by preventing an erroneous entry into the railroad crossing where the train is approaching. Further, according to the embodiment of the present invention, it is possible to improve the accuracy in the detection of the alarm sound by eliminating a stationary sound such as a moving sound.

### Second Embodiment

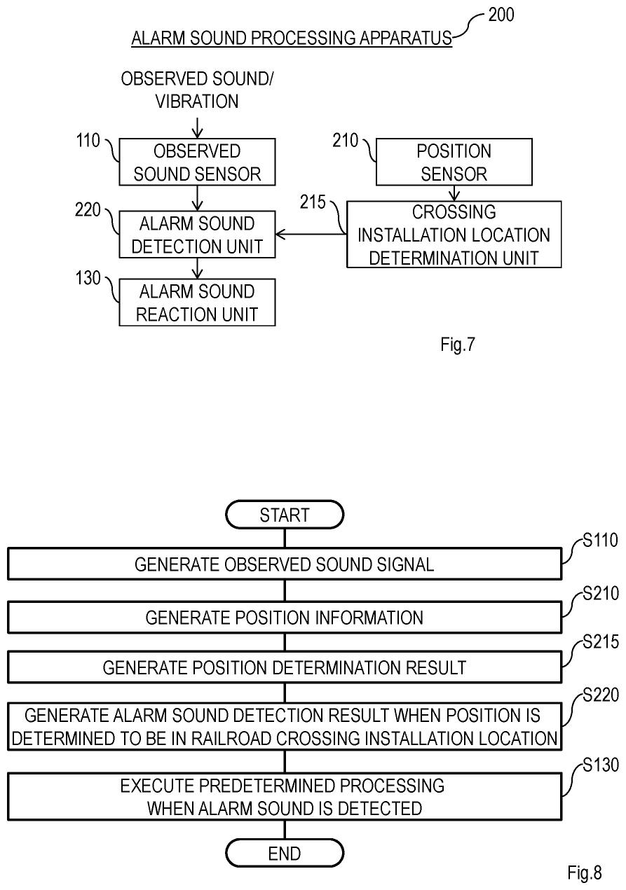

Hereinafter, an alarm sound processing apparatus 200 will be described with reference to FIGS. 7 and 8. FIG. 7 is a block diagram showing the configuration of the alarm sound processing apparatus 200. FIG. 8 is a flowchart showing the operation of the alarm sound processing apparatus 200. As shown in FIG. 7, the alarm sound processing apparatus 200 includes an observed sound sensor 110, a position sensor 210, a crossing installation location determination unit 215, an alarm sound detection unit 220, and an alarm sound reaction unit 130. The alarm sound processing apparatus 200 includes N (N is an integer equal to or larger than 1) observed sound sensors 110. The alarm sound processing apparatus 200 differs from the alarm sound processing apparatus 100 in including the alarm sound detection unit 220 instead of the alarm sound detection unit 120 and further including the position sensor 210 and the crossing installation location determination unit 215.

The operation of the alarm sound processing apparatus 200 will be described below with reference to FIG. 8. Here, only the operations in the position sensor 210, the crossing installation location determination unit 215, and the alarm sound detection unit 220 will be described.

In S210, the position sensor 210 acquires information on the position of the car being driven by the driver (hereinafter referred to as position information) and outputs the information. As the position sensor 210, for example, the Global Positioning System (GPS) can be used.

In S215, the railroad crossing installation location determination unit 215 uses the position information acquired in S210 as an input to generate, from the position information, a position determination result indicating whether or not the car being driven by the driver is located near the railroad crossing and output the generated result. The crossing installation location determination unit 215 uses a recording unit (not shown) that records map information including information on the railroad crossing position to generate, from the position information, a position determination result indicating that the car being driven by the driver is located near the railroad crossing when the car being driven by the driver is on the road passing through the railroad crossing and the distance between the position of the car being driven by the driver and the position of the railroad crossing is smaller than a predetermined threshold (the distance is equal to or smaller than the predetermined threshold). In other cases, the crossing installation location determination unit 215 may generate a position determination result indicating that the car being driven by the driver is not located near the railroad crossing.

In S220, the alarm sound detection unit 220 uses the position determination result generated in S215 and the observed sound signal generated in S110 as inputs to generate, from the observed sound signal, an alarm sound detection result indicating whether or not the observed sound contains the alarm sound at the railroad crossing when the position determination result indicates that the car being driven by the driver is located near the railroad crossing, and the alarm sound detection unit 220 outputs the generated result.

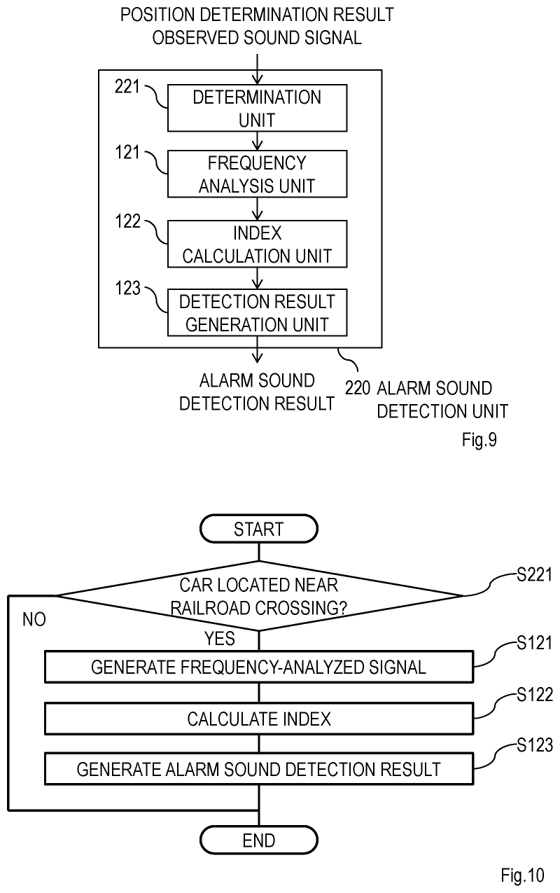

Hereinafter, an example of the alarm sound detection unit 220 will be described with reference to FIGS. 9 and 10. FIG. 9 is a block diagram showing the configuration of the alarm sound detection unit 220. FIG. 10 is a flowchart showing the operation of the alarm sound detection unit 220. As shown in FIG. 9, the alarm sound detection unit 220 includes a determination unit 221, a frequency analysis unit 121, an index calculation unit 122, and a detection result generation unit 123. The alarm sound detection unit 220 differs from the alarm sound detection unit 120 of the first embodiment only in including the determination unit 221.

The operation of the alarm sound detection unit 220 will be described below with reference to FIG. 10. Here, only the operation of the determination unit 221 will be described.

In S221, the determination unit 221 uses the position determination result generated in S215 as an input, and when the position determination result indicates that the car being driven by the driver is located near the railroad crossing, the determination unit 221 continues the processing, while in other cases, the determination unit 221 ends the processing. When the processing is continued, the processing by each of the frequency analysis unit 121, the index calculation unit 122, and the detection result generation unit 123 (the processing in each of S121 to S123) is executed.

### Modification 1

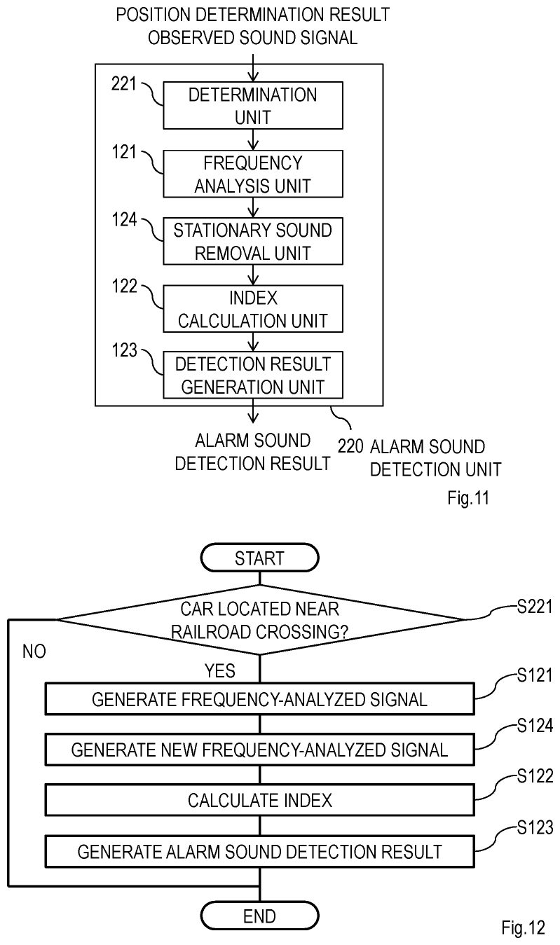

Similarly to the alarm sound detection unit 120 in (Modification) of the first embodiment, the alarm sound detection unit 220 may be configured to remove a stationary sound contained in the observed sound (vibration related to a stationary sound contained in vibration related to the observed sound) (cf. FIGS. 11 and 12).

### Modification 2

It may be determined whether or not the car is located near the railroad crossing by using information except for the position information (information contributing to the determination as to whether or not the car is located near the railroad crossing). An example of the information contributing to the determination as to whether or not the car is located near the railroad crossing is information on whether or not the railroad crossing is included in an image taken by a camera mounted on the car.

The determination may be made by combining the position information and the information contributing to the determination as to whether or not the car is located near the railroad crossing. How the crossing installation location determination unit 215 generates the position determination result in this case will be described. For example, the crossing installation location determination unit 215 may generate the position determination result indicating that the car is located near the railroad crossing when all of the determination result based on the position information and the determination results based on the information except for the position information indicate that the car is near the railroad crossing. Further, for example, the crossing installation location determination unit 215 may calculate indexes each indicating the degree of correctness of the determination result based on each information (for example, the index takes a value of 0 or more and 1 or less, where 0 indicates that the car is not near and 1 indicates that the car is near), and based on the average of the indexes, the crossing installation location determination unit 215 may generate the position determination result indicating that the car is located near the railroad crossing.

According to the embodiment of the present invention, it is possible to support the operation of the car by the driver when an alarm sound notifying the approach of a train is sounding at a railroad crossing. Specifically, it is possible to call the driver's attention by notifying the driver that a train is approaching a railroad crossing or to apply a brake to the car driven by the driver. In addition, according to the embodiment of the present invention, due to the use of the information on the position of the car, it is possible to reduce malfunction related to the support operation.

### Supplementary Note

The device of the present invention has, for example, as a single hardware entity, an input unit to which a keyboard or the like can be connected, an output unit to which a liquid crystal display or the like can be connected, a communication unit to which a communication device (e.g., a communication cable) capable of communicating with the outside of the hardware entity can be connected, a central processing unit (CPU) (which may include cache memory, a register, etc.), a random-access memory (RAM) or a read-only memory (ROM) which is a memory, an external storage device which is a hard disk, and a bus connected so that data can be exchanged among the input unit, the output unit, the communication unit, the CPU, the RAM, the ROM, and the external storage device. If necessary, a device (drive) capable of reading and writing a recording medium such as a compact disc read-only memory (CD-ROM) may be provided in the hardware entity. Examples of a physical entity having such hardware resources include a general-purpose computer.

Programs required to realize the functions described above and data required in the processing of each of the programs are stored in the external storage device of the hardware entity (this is not limited to the external storage device, but, for example, the programs may be previously stored into the ROM which is a read-only storage device). Further, data obtained by the processing of each of these programs and the like are appropriately stored into the RAM or the external storage device.

In the hardware entity, each program stored in the external storage device (or the ROM, etc.) and data required for the processing of each program are read into the memory as necessary and are interpreted, executed, and processed by the CPU as appropriate. As a result, the CPU realizes a predetermined function (each of the constituent elements expressed above as . . . unit, . . . means, etc.).

As described above, when the processing function in the hardware entity (the device of the present invention) described in the above embodiment is realized by the computer, the processing content of the function to be included in the hardware entity is described by a program. By executing the program on the computer, the processing function in the hardware entity is realized on the computer.

The program describing the processing content can be previously recorded on a computer-readable recording medium. The computer-readable recording medium may be any recording medium such as a magnetic recording device, an optical disk, a magneto-optical recording medium, or a semiconductor memory. Specifically, for example, a hard disk drive, a flexible disk, a magnetic tape, or the like can be used as the magnetic recording device, a digital versatile disc (DVD), a DVD-random-access memory (RAM), a compact disc read-only memory (CD-ROM), a CD-recordable (R)/CD-rewritable (RW), or the like can be used as the optical disk, a magneto-optical disc (MO), or the like can be used as the magneto-optical recording medium, and an electrically erasable and programmable read-only memory (EEP-ROM) or the like can be used as the semiconductor memory.

The program is distributed by, for example, selling, transferring, or lending a portable recording medium, such as a DVD or a CD-ROM in which the program is recorded. Further, the program may be distributed by previously storing the program into a storage device of a server computer and transferring the program from the server computer to another computer via the network.

The computer executing such a program first stores, into its own storage device, a program recorded on a portable recording medium or a program transferred from the server computer, for example. Then, at the time of executing the processing, the computer reads the program stored in its own storage device and executes the processing in accordance with the read program. As another embodiment of the program, the computer may read the program directly from the portable recording medium and execute the processing in accordance with the program, and further, each time a program is transferred from the server computer to the computer, the computer may sequentially execute the processing in accordance with the received program. The processing described above may be executed by a so-called application service provider (ASP) type service that realizes a processing function only by instruction of the execution and acquisition of the result without transferring the program from the server computer to the computer. Note that the programs in the present embodiment include information that is used for processing by an electronic computer and is equivalent to a program (such as data that is not a direct command to a computer but has the nature to regulate the processing of the computer).

In the present embodiment, each hardware entity has been configured by executing a predetermined program on the computer, but at least a part of the processing content may be realized by hardware.

The above description of the embodiments of the present invention has been presented for the purposes of illustration and description. There is no intention to be exhaustive or to limit the invention to the exact form disclosed. Modifications and variations are possible from the teachings described above. The embodiments have been chosen and expressed in order to provide the best illustration of the principles of the present invention and to enable those skilled in the art to utilize the present invention in various embodiments, or with various modifications applied, as appropriate for contemplated practical use. All such modifications and variations are within the scope of the present invention as defined by the appended claims having been interpreted in accordance with a range that is provided in a fair, lawful, and equitable manner.

1. An alarm sound processing apparatus comprising:
processing circuitry configured to: execute
an observed sound sensor that generates an observed sound signal from an observed sound or vibration related to the observed sound;
an alarm sound detection processing that generates an alarm sound detection result indicating whether the observed sound contains an alarm sound at a railroad crossing from the observed sound signal; and
an alarm sound reaction processing that executes processing for issuing a warning to notify a driver that a train is approaching the railroad crossing and/or executes processing for applying a brake to a car driven by the driver when the alarm sound detection result indicates that the alarm sound is contained.

2. The alarm sound processing apparatus according to claim 1, wherein the alarm sound detection processing includes
a frequency analysis processing that generates a frequency-analyzed signal from the observed sound signal,
an index calculation processing that calculates an index indicating a degree of possibility that the observed sound contains the alarm sound at the railroad crossing from the frequency-analyzed signal, and
a detection result generation processing that generates the alarm sound detection result from the index.

3. The alarm sound processing apparatus according to claim 2,
wherein the alarm sound detection processing further includes a stationary sound removal processing that generates, from the frequency-analyzed signal, a frequency-domain stationary sound signal corresponding to a stationary sound contained in the observed sound or vibration related to a stationary sound contained in vibration related to the observed sound,the stationary sound removal processing taking a signal, generated by subtracting the frequency-domain stationary sound signal from the frequency-analyzed signal, as a new frequency-analyzed signal.

4. An alarm sound processing method comprising:
an observed sound signal generation step of the alarm sound processing apparatus generating an observed sound signal from an observed sound or vibration related to the observed sound;
an alarm sound detection step of the alarm sound processing apparatus generating an alarm sound detection result indicating whether the observed sound contains an alarm sound at a railroad crossing from the observed sound signal; and
an alarm sound reaction step of the alarm sound processing apparatus executing processing for issuing a warning to notify a driver that a train is approaching the railroad crossing and/or executing processing for applying a brake to a car driven by the driver when the alarm sound detection result indicates that the alarm sound is contained.

5. A non-transitory computer-readable storage medium which stores a program for causing a computer to function as the alarm sound processing apparatus according to any one of claims 1 to 3.
